(19) United States
(12) Patent Application Publication
(10) Pub. No.: US 2013/0148215 A1
(43) Pub. Date: Jun. 13, 2013

(54) IMAGING DEVICE

(71) Applicant: Panasonic Corporation, Osaka (JP)

(72) Inventors: Tetsuya MORI, Osaka (JP); Shusaku YAMAMOTO, Osaka (JP); Itaru TAKATA, Osaka (JP)

(73) Assignee: Panasonic Corporation, Osaka (JP)

(21) Appl. No.: 13/692,948

(22) Filed: Dec. 3, 2012

(30) Foreign Application Priority Data
Dec. 7, 2011 (JP) 2011-267769

(51) Int. Cl. G02B 7/02

(52) U.S. Cl. CPC G02B 7/021
USPC 359/819

(57) ABSTRACT

A digital camera comprising a lens barrel linking plate, a frame unit, and first and second lens barrels. The frame unit has first to third bosses that are linked to the lens barrel linking plate. The first and second lens barrels are disposed between the lens barrel linking plate and the frame unit. The first to third bosses are each disposed around the outer periphery of the first lens barrel.

### CROSS-REFERENCE TO RELATED APPLICATIONS

This application claims priority under 35 U.S.C. §119 to Japanese Patent Application No. 2011-267769, filed on Dec. 7, 2011. The entire disclosure of Japanese Patent Application No. 2011-267769 is hereby incorporated herein by reference.

### BACKGROUND

1. Technical Field

The technology disclosed herein relates to an imaging device equipped with a plurality of lens barrels.

2. Background Information

Japanese Laid-Open Patent Application 2003-335180 proposes a method for linking both ends of a panel member that supports two lens barrels to a base component that supports the panel member, in a support structure constituted by this panel member and this base component.

### SUMMARY

With the method of Japanese Laid-Open Patent Application 2003-335180, however, since both ends of the panel member are linked to the base component, there is the risk that the optical axes of the two lens barrels will deviate as a result of distortion of the entire panel member when the panel member is fixed to the base component.

The technology disclosed herein is conceived in light of the above situation, and it is an object thereof to provide an imaging device with which deviation of the optical axes of a plurality of lens barrels can be suppressed.

An imaging device disclosed herein includes a frame unit, a linking frame having a first linking component, a second linking component, and a third linking compenent; the first, second, and third linking components are linked to the frame unit; a first lens barrel and a second lens barrel, the first and second lens barrels disposed between the frame unit and the linking frame; wherein the first, second, and third linking components are disposed around an outer periphery of the first lens barrel.

### BRIEF DESCRIPTION OF DRAWINGS

FIG. 1 is an oblique view of a digital camera of an embodiment;

FIG. 2 is a front view of a digital camera of an embodiment;

FIG. 3 is an exploded oblique view of a digital camera of an embodiment;

FIG. 4 is an exploded oblique view of a frame assembly of an embodiment;

FIG. 5 is an exploded oblique view of a frame assembly of an embodiment;

FIG. 6 is an oblique view of a frame unit of an embodiment;

FIG. 7 is an oblique view of a lens barrel unit of an embodiment;

FIG. 8 is an exploded oblique view of a lens barrel unit of an embodiment;

FIG. 9 is an exploded oblique view of a lens barrel unit of an embodiment;

FIG. 10 is a cross section along the A-A line in FIG. 9; and

FIG. 11 is a rear view of a frame assembly pertaining to an embodiment.

### DETAILED DESCRIPTION OF EMBODIMENTS

Next, an embodiment of the present invention will be described with references to the drawings. In the description of the drawings that follows, those portions that are the same or similar will be given the same or similar numbers. The drawings, however, are merely schematic representations, and the dimensional proportions and so forth may differ from those in reality. Therefore, specific dimensions and the like should be determined through reference to the following description. Naturally, the dimensional relations and proportions may vary from one drawing to the next. From this disclosure, it will be apparent to those skilled in the art that the following descriptions of the embodiments are provided for illustration only and not for the purpose of limiting the invention as defined by the appended claims and their equivalents.

In the following embodiment, a digital camera will be described as an example of an imaging device. In the following description, assuming that the digital camera is in its normal orientation (hereinafter also referred to as landscape orientation), the direction facing the subject will be referred to as “forward,” the direction facing away from the subject as “rearward,” vertically upward as “upward,” vertically downward as “downward,” to the right in a state of facing directly at the subject as “to the right,” and to the left in a state of facing directly at the subject as “to the left.”

Overall Configuration of Digital Camera 100

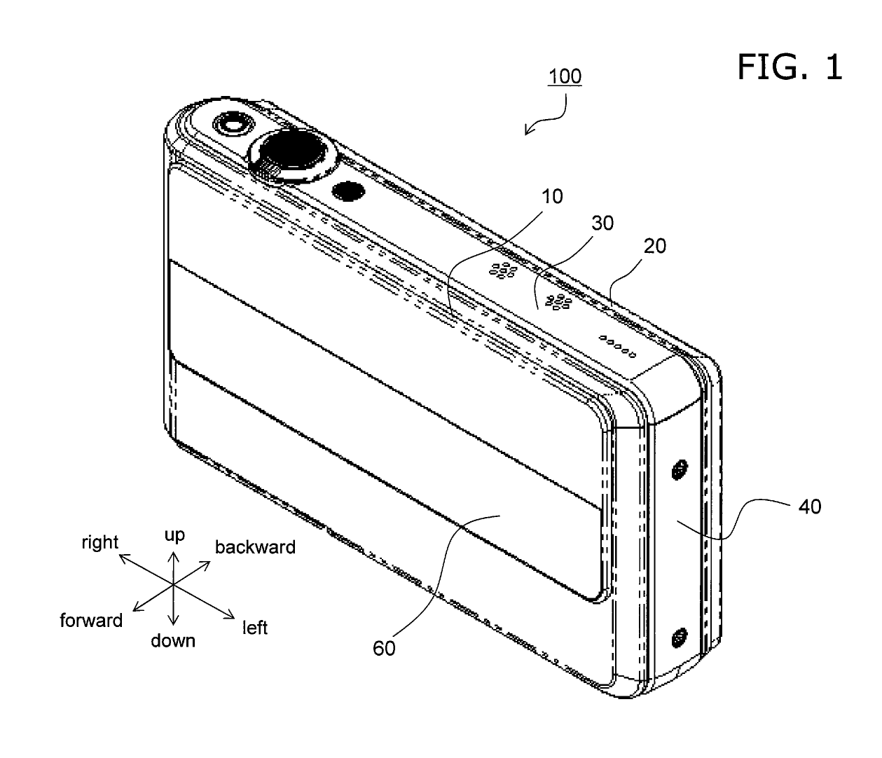

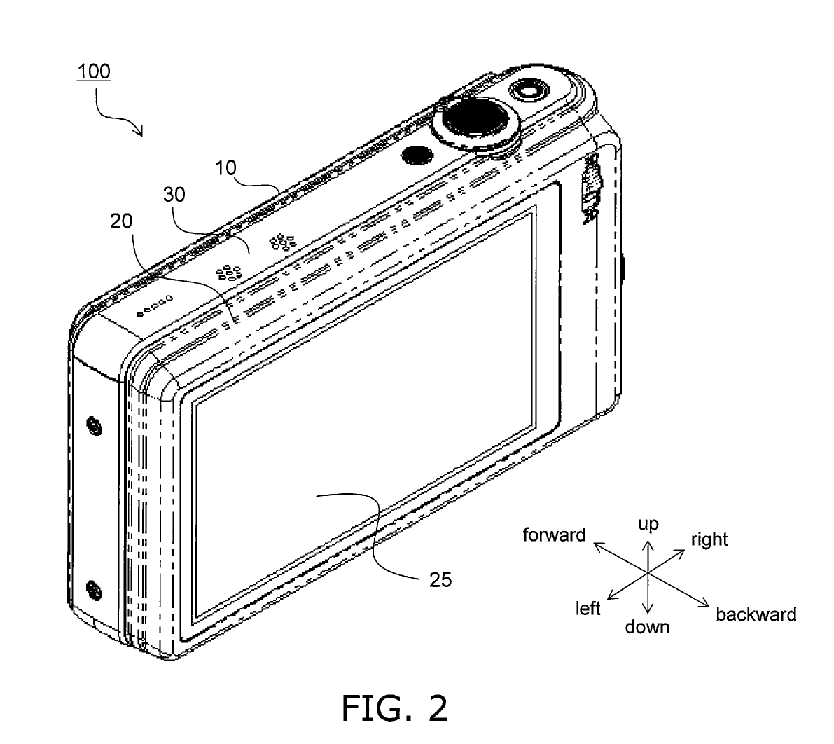

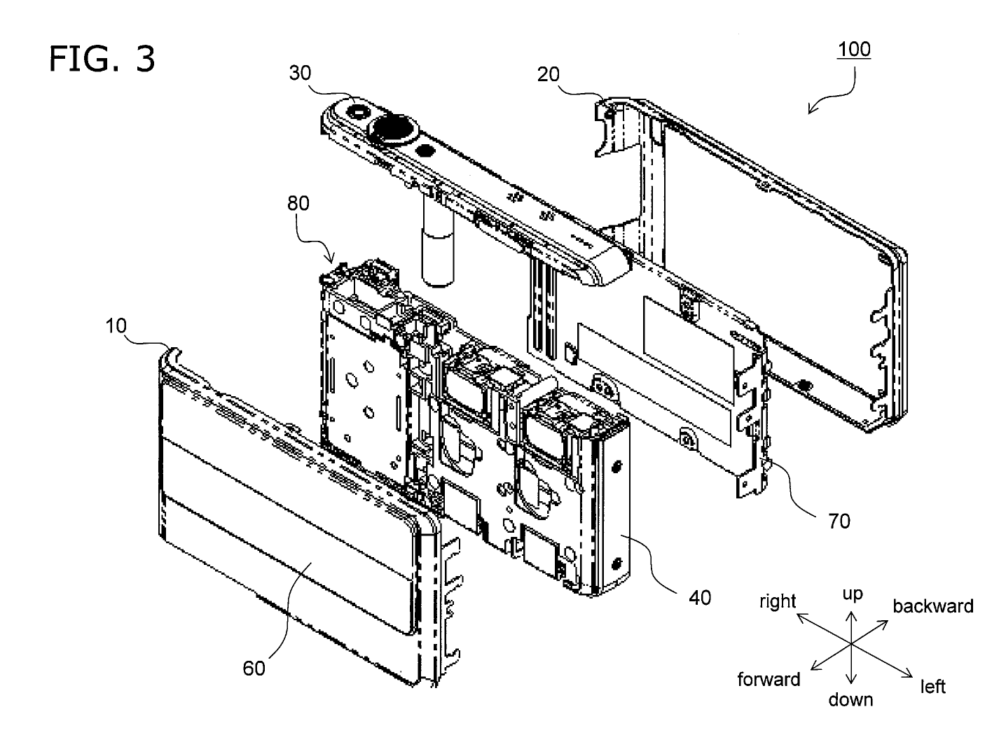

The overall configuration of the digital camera 100 pertaining to an embodiment will be described with references to the drawings. FIG. 1 is an oblique view of the digital camera 100 pertaining to an embodiment as seen from the front. FIG. 2 is an oblique view of the digital camera 100 pertaining to an embodiment as seen from the rear. FIG. 3 is an exploded oblique view of the digital camera 100 pertaining to an embodiment.

The digital camera 100 comprises a front panel 10 (an example of a “panel member”), a rear panel 20, a top panel 30, a side panel 40, a slide cover 60, a frame plate 70, and a frame assembly 80. The front panel 10, the rear panel 20, the top panel 30, and the side panel 40 constitute a housing.

The front panel 10 constitutes the panel on the front side of the housing. The rear panel 20 constitutes the panel on the rear side of the housing. The top panel 30 constitutes the panel on the top side of the housing. The side panel 40 constitutes the panel on the left side of the housing. As shown in FIG. 3, the right side face of the housing is formed by bending the right end of the front panel 10 and the right end of the rear panel 20 around to meet.

The slide cover 60 is attached to the front panel 10 so as to be able to slide in the up and down direction. The slide cover 60 is closed by sliding upward and opened by sliding downward. A monitor 25 is fixed on the inside of the rear panel 20. The frame plate 70 supports the monitor 25. The frame assembly 80 is disposed between the front panel 10 and the frame plate 70. The frame assembly 80 is disposed between the front panel 10 and the frame plate 70. The frame assembly 80 is covered by the slide cover 60 when the slide cover 60 is closed, and is exposed from the slide cover 60 when the slide cover 60 is open. The configuration of the frame assembly 80 will be discussed below.

Configuration of Frame Assembly 80

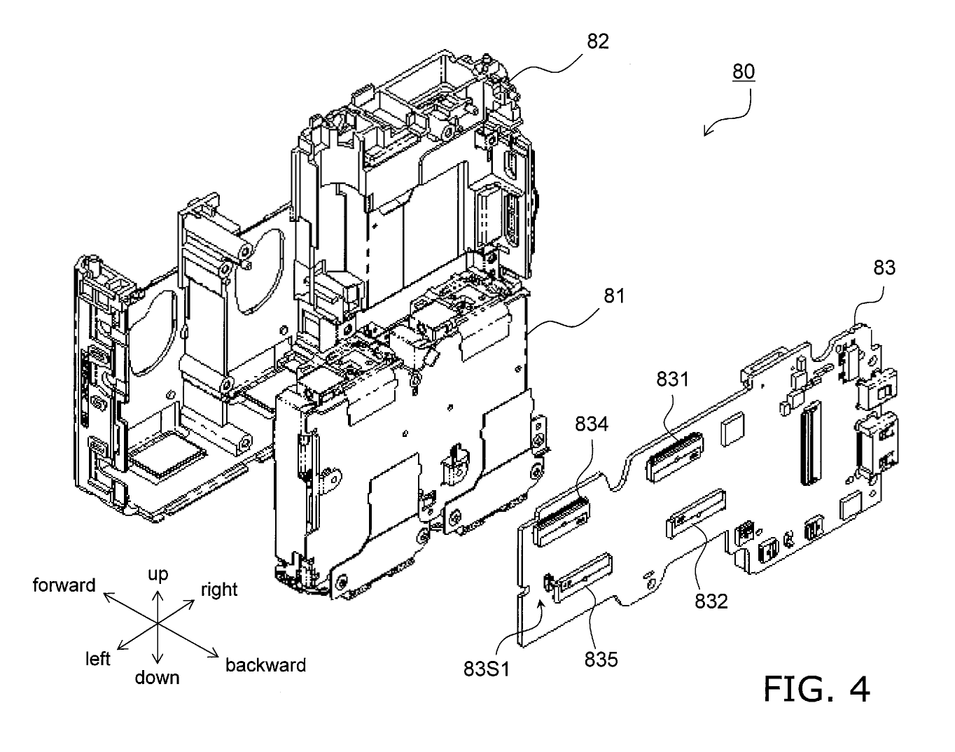

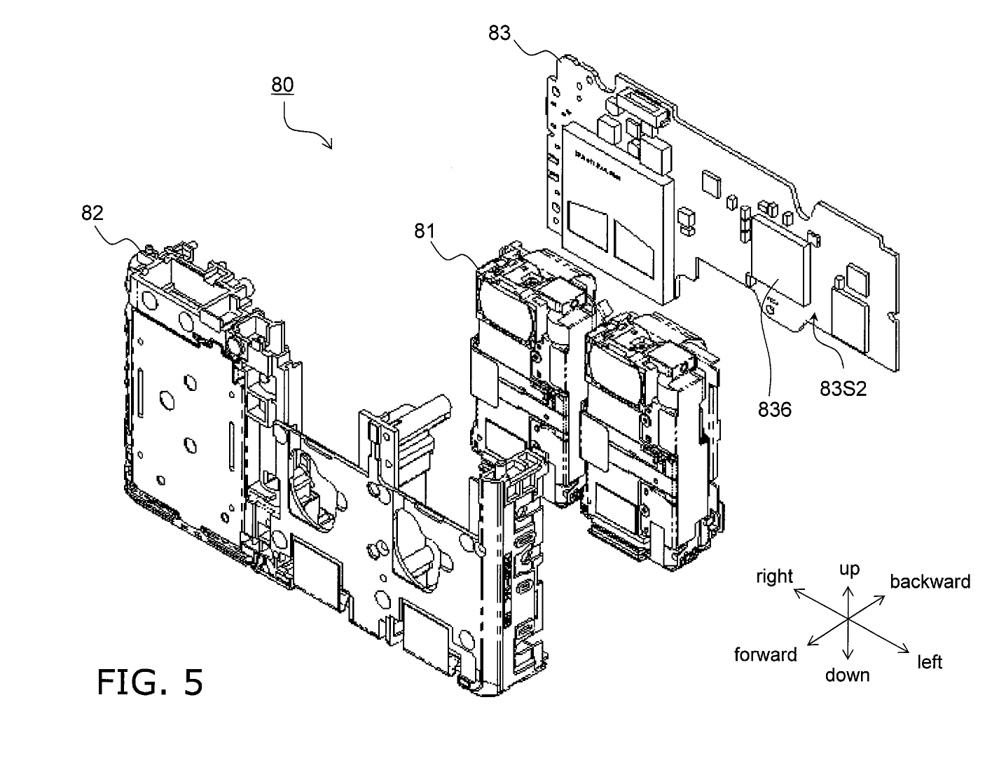

The configuration of the frame assembly 80 pertaining to an embodiment will be described with references to the drawings. FIG. 4 is an exploded oblique view of the frame assembly 80 pertaining to an embodiment as seen from the rear. FIG. 5 is an exploded oblique view of the frame assembly 80 pertaining to an embodiment as seen from the front.

The frame assembly 80 has a lens barrel unit 81, a frame unit 82, and a substrate unit 83.

The lens barrel unit 81 is disposed between the frame unit 82 and the substrate unit 83. The lens barrel unit 81 is fixed to the frame unit 82 disposed in front of the lens barrel unit 81. How the lens barrel unit 81 and the frame unit 82 are fixed is discussed below.

The frame unit 82 is a rectangular panel member extending in the left and right direction (an example of a specific direction). The frame unit 82 is linked to the lens barrel unit 81.

The substrate unit 83 is disposed to the rear of the lens barrel unit 81. The substrate unit 83 has a substrate unit rear face 83S1 that is opposite the frame plate 70, and a substrate unit front face 83S2 provided on the opposite side from the substrate unit rear face 83S1. As shown in FIG. 4, a lens barrel connector 831, a lens barrel connector 834, an imaging element connector 832, and an imaging element connector 835 are disposed on the substrate unit rear face 83S1. As shown in FIG. 5, an integrated circuit 836 is disposed on the substrate unit front face 83S2. The layout relation between the connectors and the integrated circuit 836 is discussed below.

Configuration of Frame Unit 82

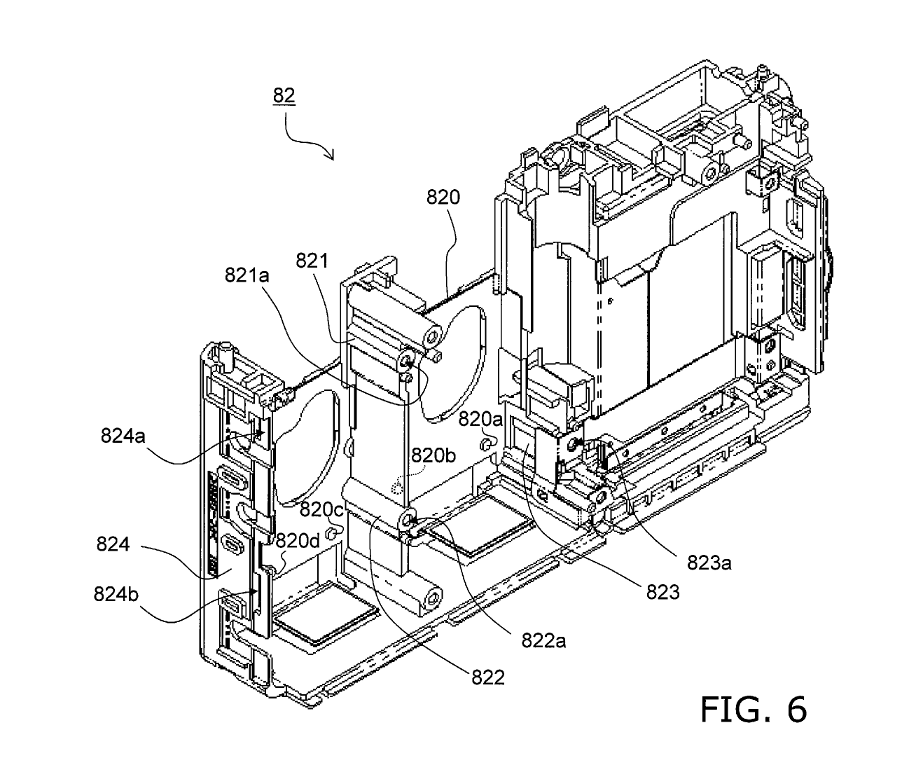

The configuration of the frame unit pertaining to an embodiment will be described with references to the drawing. FIG. 6 is an oblique view of the frame unit 82 pertaining to an embodiment.

The frame unit 82 comprises a main plate 820, a first boss 821, a second boss 822, a third boss 823, and a side plate 824.

The main plate 820 is disposed so as to be opposite the front panel 10 (see FIG. 3). The inner face of the main plate 820 has a first boss pin 820a, a second boss pin 820b, a third boss pin 820c, and a fourth boss pin 820d that protrude toward the lens barrel unit 81 (see FIG. 4). The distal end faces of the first boss pin 820a, the second boss pin 820b, the third boss pin 820c, and the fourth boss pin 820d are provided in parallel and at the mutually same positions on the main plate 820. When the frame unit 82 is linked to the lens barrel unit 81, the first boss pin 820a, the second boss pin 820b, the third boss pin 820c, and the fourth boss pin 820d are each separated by a specific distance from the lens barrel unit 81.

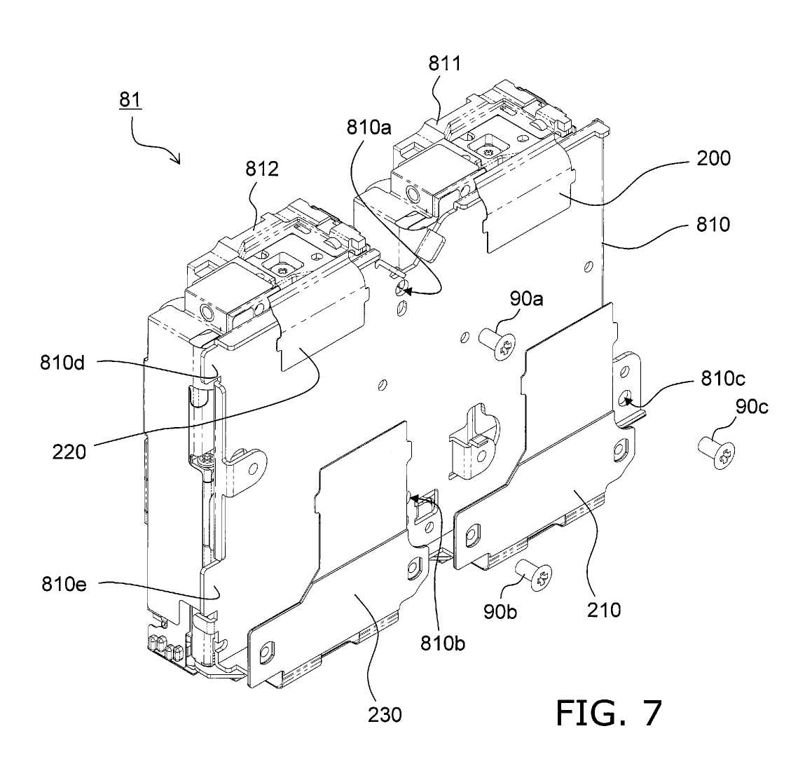

The first to third bosses 821 to 823 are used to screw down the lens barrel unit 81. The first boss 821 has a first boss hole 821a. The second boss 822 has a second boss hole 822a. The third boss 823 has a third boss hole 823a. The first to third bosses 821 to 823 are disposed evenly spaced around the outer periphery of the first lens barrel 811 (see FIG. 7). More specifically, the first and second bosses 821 and 822 are disposed between first and second lens barrels 811 and 812, and the third boss 823 is disposed on the opposite side from the first and second bosses 821 and 822 with the first lens barrel 811 sandwiched in between. As discussed below, first to third screws 90a to 90c (see FIG. 7) are inserted into the first to third bosses 821 to 823.

The side plate 824 is provided on the left end of the main plate 820. The side plate 824 covers the left side face of the lens barrel unit 81. The side plate 824 has a first slit 824a and a second slit 824b. A first tab 810d of the lens barrel unit 81 (see FIG. 7) is inserted into the first slit 824a. A gap is provided between the first slit 824a and the first tab 810d. A second tab 810e of the lens barrel unit 81 (see FIG. 7) is inserted into the second slit 824b. A gap is provided between the second slit 824b and the second tab 810e.

Configuration of Lens Barrel Unit 81

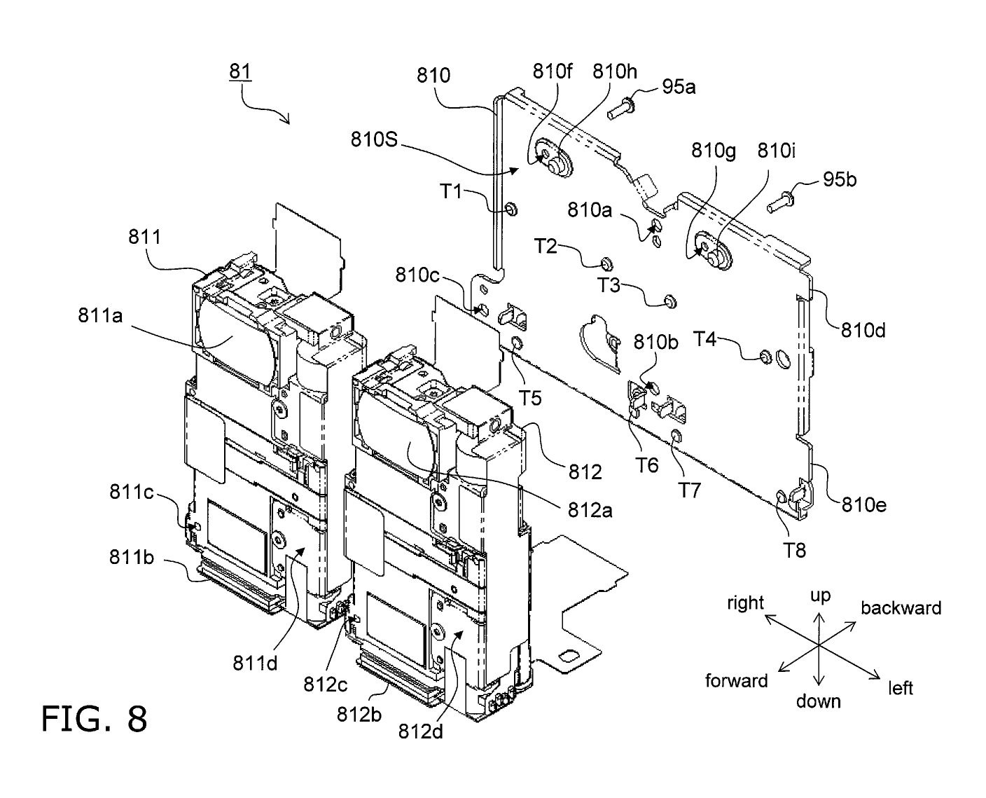

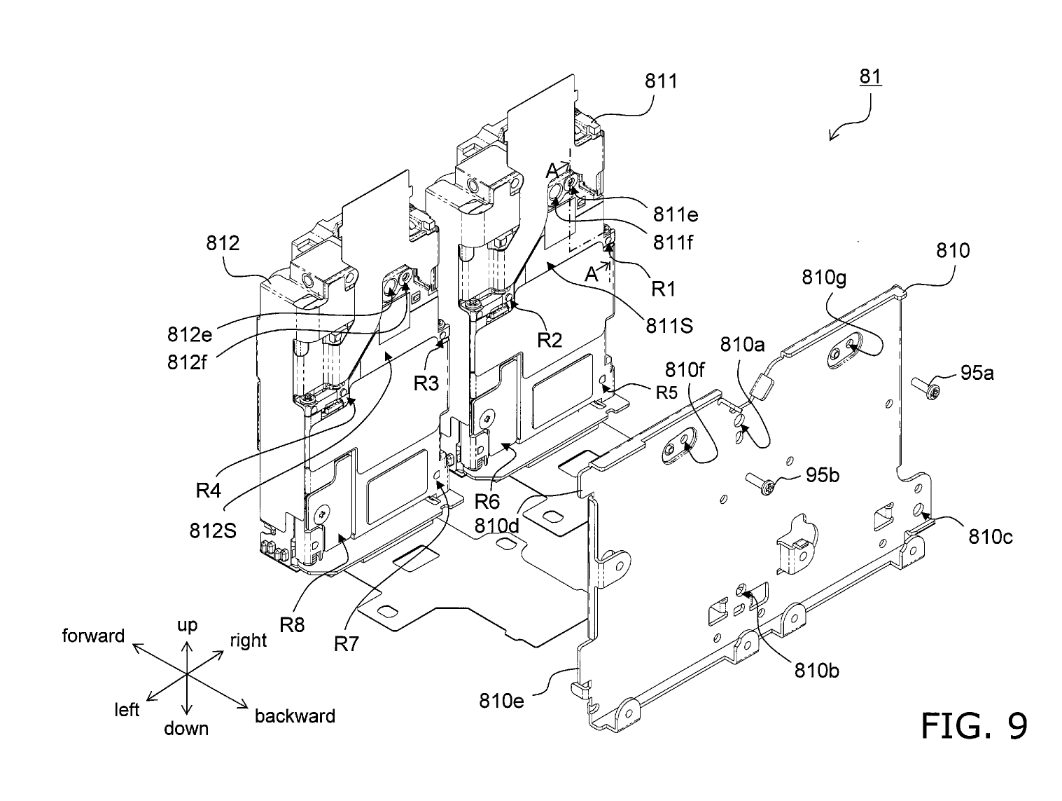

The configuration of the lens barrel unit 81 pertaining to an embodiment will be described with references to the drawings. FIG. 7 is an oblique view of a lens barrel unit pertaining to an embodiment. FIG. 8 is an exploded oblique view of a lens barrel unit pertaining to an embodiment. FIG. 9 is an exploded oblique view of a lens barrel unit pertaining to an embodiment.

The lens barrel unit 81 has the first lens barrel 811, the second lens barrel 812, and a lens barrel linking plate 810.

As shown in FIG. 9, the first lens barrel 811 has a first lens barrel rear face 811S, and the second lens barrel 812 has a second lens barrel rear face 812S. The first lens barrel rear face 811S and the second lens barrel rear face 812S are disposed facing a linking plate front face 810s of the lens barrel linking plate 810 (see FIG. 8).

As shown in FIG. 8, the first lens barrel 811 and the second lens barrel 812 are arranged adjacent to each other in a state in which a first lens component 811a and a second lens component 812a are facing forward. The first lens barrel 811 is disposed at a position closer to the center of the frame unit 82 than the second lens barrel 812 in the left and right direction. The first lens barrel 811 has a first lens barrel flexible substrate 200 and a second imaging element flexible substrate 210. The second lens barrel 812 has a second lens barrel flexible substrate 220 and a second imaging element flexible substrate 230.

The lens barrel linking plate 810 is disposed with the substrate unit 83 on one side and the first lens barrel 811 and the second lens barrel 812 on the other. The lens barrel linking plate 810 is formed in a flat shape so that better positional accuracy can be obtained.

As shown in FIG. 8, the lens barrel linking plate 810 has the linking plate front face 810s, a first hole 810a, a second hold 810b, a third hold 810c, the first tab 810d, the second tab 810e, a first screw hole 810f, a second screw hole 810g, a first positioning boss 810h, a second positioning boss 810i, a first contact boss T1, a second contact boss T2, a third contact boss T3, a fourth contact boss T4, a fifth contact boss T5, a sixth contact boss T6, a seventh contact boss T7, and an eighth contact boss T8. The first contact boss T1 and the second contact boss T2 are examples of two convex components that protrude toward the first lens barrel 811, and the third contact boss T3 and the fourth contact boss T4 are examples of two convex components that protrude toward the second lens barrel 812.

As shown in FIGS. 7 and 9, the lens barrel linking plate 810 is screwed to the frame unit 82 with the first to third screws 90a to 90c inserted into the first to third holes 810a to 810c. The first to third screws 90a to 90c are inserted into first to third bosses 821, 822a, and 823a of the frame unit 82 (see FIG. 6).

The planar accuracy of the lens barrel linking plate 810 is managed within a triangular region formed on the inside of the first to third holes 810a to 810c. The first tab 810d and the second tab 810e are inserted respectively into the first slit 824a and the second slit 824b of the frame unit 82 with a gap in between. Accordingly, when subjected to a falling impact, the first tab 810d and the second tab 810e hit the inner peripheral faces of the first slit 824a and the second slit 824b, respectively, which restricts the second lens barrel 812 from hitting the frame unit 82.

The first lens barrel flexible substrate 200 and a second lens barrel flexible substrate 220 are provided between the lens barrel linking plate 810 on one side and the first lens barrel 811 and the second lens barrel 812 on the other. The first lens barrel flexible substrate 200 and the second lens barrel flexible substrate 220 transmit signals for controlling the first lens barrel 811 and the second lens barrel 812. A first imaging element flexible substrate 210 and the second imaging element flexible substrate 230 are provided between the lens barrel linking plate 810 on one side and the first lens barrel 811 and the second lens barrel 812 on the other. The first imaging element flexible substrate 210 and the second imaging element flexible substrate 230 transmit signals from imaging elements.

As shown in FIG. 8, the first lens barrel 811 has the first lens component 811a, a first imaging element 811b, a first front contact face 811c, and a second front contact face 811d. As shown in FIG. 9, the first lens barrel 811 also has a first screw hole 811e, a first positioning hole 811f, the first rear face 811S, a first rear contact face R1, a second rear contact face R2, a third rear contact face R5, and a fourth rear contact face R6.

The first lens component 811a is a transparent member disposed in front of the upper part of the first lens barrel 811. The first imaging element 811b is disposed at the bottom part of the first lens barrel 811. The front end of the first imaging element 811b protrudes forward from the first lens barrel 811. The first front contact face 811c and the second front contact face 811d are disposed on either side of the front face at the lower end of the first lens barrel 811. The first front contact face 811c and the second front contact face 811d are opposite the first boss pin 820a and the second boss pin 820b of the frame unit 82 with a specific gap in between. Accordingly, when subjected to a falling impact, the first front contact face 811c and the second front contact face 811d hit the first boss pin 820a and the second boss pin 820b, which prevents the first imaging element 811b from hitting the front panel 10.

The first screw hole 811e, the first positioning hole 811f, the first rear contact face R1, and the second rear contact face R2 are formed at the lens barrel rear face 811S. The first lens barrel 811 is fixed to the lens barrel linking plate 810 in a state in which the first and second contact bosses T1 and T2 of the lens barrel linking plate 810 are in contact with the first and second rear contact faces R1 and R2 by tightening a first screw 95a into the first screw hole 811e in a state in which the first positioning boss 810h of the lens barrel linking plate 810 has been inserted into the first positioning hole 811f.

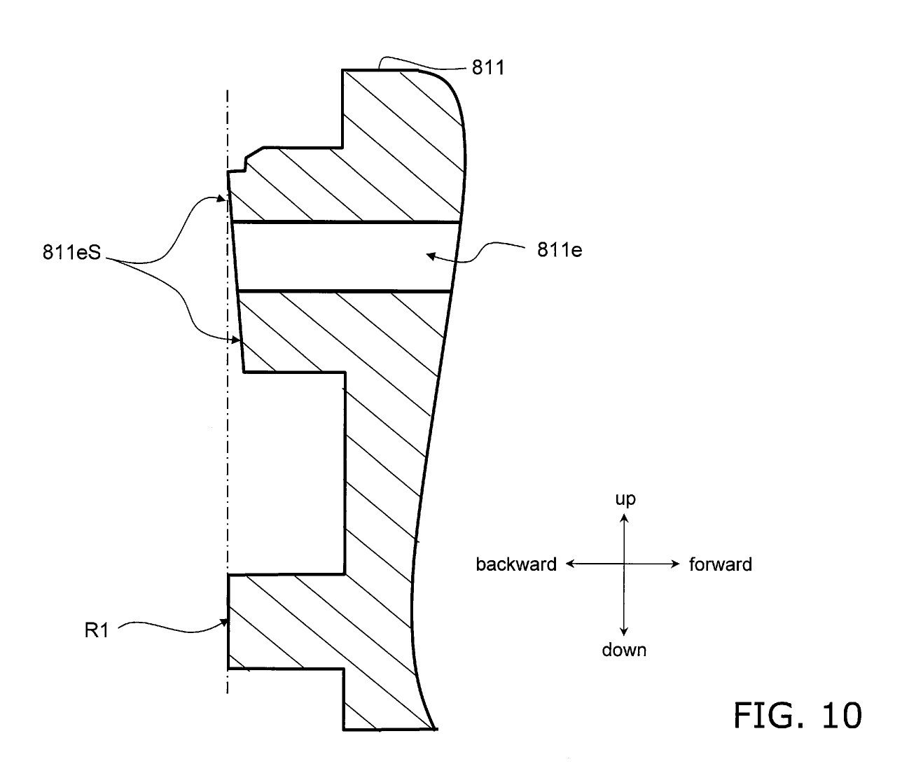

FIG. 10 is a cross section along the A-A line in FIG. 9. As shown in FIG. 10, the first lens barrel 811 has a rear end face 811eS in which the first screw hole 811e is formed. The rear end face 811eS is tilted with respect to the first rear contact face R1. More specifically, the rear end face 811eS is cut out, with the depth increasing toward the first rear contact face R1. Accordingly, the first rear contact face R1 can be snugly fitted against the first contact boss T1 of the lens barrel linking plate 810 by tightening the first screw 95a into the first screw hole 811e. Although not depicted, the rear end face 811eS is also tilted with respect to the second rear contact face R2, which is parallel to the first rear contact face R1.

The third rear contact face R5 and the fourth rear contact face R6 are disposed on either side at the lower part of the first rear face 811S of the first lens barrel 811. The third rear contact face R5 and the fourth rear contact face R6 are disposed away from the fifth contact boss T5 and the sixth contact boss T6 of the lens barrel linking plate 810, and when subjected to a falling impact, hit the fifth contact boss T5 and the sixth contact boss T6, which prevents the first imaging element 811b from hitting the lens barrel linking plate 810.

As shown in FIG. 8, the second lens barrel 812 has the second lens component 812a, a second imaging element 812b, a third front contact face 812c, and a fourth front contact face 812d. As shown in FIG. 9, the second lens barrel 812 has a second screw hole 812e, a second positioning hole 812f, the second rear face 812S, a first rear contact face R3, a second rear contact face R4, a third rear contact face R7, and a fourth rear contact face R8.

The second lens component 812a is a transparent member disposed in front of the upper part of the second lens barrel 812. The second imaging element 812b is disposed at the bottom part of the second lens barrel 812. The front end of the second imaging element 812b protrudes forward from the second lens barrel 812. The third front contact face 812c and the fourth front contact face 812d are disposed on either side of the front face at the lower end of the second lens barrel 812. The third front contact face 812c and the fourth front contact face 812d are opposite the third boss pin 820c and the fourth boss pin 820d of the frame unit 82 with a specific gap in between. Accordingly, when subjected to a falling impact, the third front contact face 812c and the fourth front contact face 812d hit the third boss pin 820c and the fourth boss pin 820d, which prevents the second imaging element 812b from hitting the front panel 10.

The second screw hole 812e, the second positioning hole 812f, the first rear contact face R3, and the second rear contact face R4 are formed at the lens barrel rear face 812S. The second lens barrel 812 is fixed to the lens barrel linking plate 810 in a state in which the third and fourth contact bosses T3 and T4 of the lens barrel linking plate 810 are in contact with the first and second rear contact faces R3 and R4 by tightening a second screw 95b into the second screw hole 812e in a state in which the second positioning boss 810i of the lens barrel linking plate 810 has been inserted into the second positioning hole 812f.

Although not depicted, the rear end face in which the second screw hole 812e is formed is cut out, with the depth increasing toward the first and second rear contact faces R3 and R4, and is tilted with respect to the first and second rear contact faces R3 and R4. Accordingly, the first and second rear contact faces R3 and R4 can be snugly fitted against the third and fourth contact bosses T3 and T4 of the lens barrel linking plate 810 by tightening the second screw 95b into the second screw hole 812e.

The third rear contact face R7 and the fourth rear contact face R8 are disposed on either side at the lower part of the second rear face 812S of the second lens barrel 812. The third rear contact face R7 and the fourth rear contact face R8 are disposed away from the seventh contact boss T7 and the eighth contact boss T8 of the lens barrel linking plate 810, and when subjected to a falling impact, hit the seventh contact boss T7 and the eighth contact boss T8, which prevents the second imaging element 812b from hitting the lens barrel linking plate 810.

Layout Position of Integrated Circuit 836

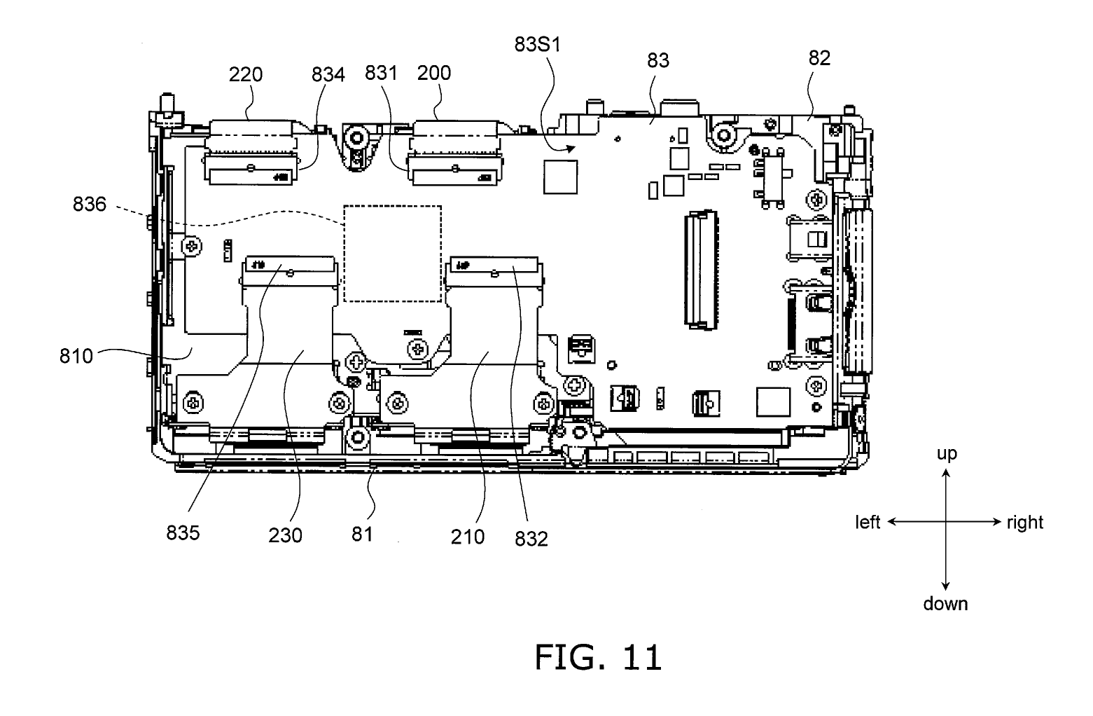

The layout position of the integrated circuit 836 will be described with references to the drawings. FIG. 11 is a see-through diagram of the frame assembly 80 pertaining to an embodiment as seen from the rear.

The substrate unit 83 has a first lens barrel connector 831, a second lens barrel connector 834, a first imaging element connector 832, and a second imaging element connector 835 disposed on the substrate unit rear face 83S1. The substrate unit 83 also has the integrated circuit 836 disposed on the substrate unit front face 83S2.

The first lens barrel connector 831 and the second lens barrel connector 834 are aligned in the left and right direction at the upper end of the substrate unit rear face 83S1. The first imaging element connector 832 and the second imaging element connector 835 are aligned in the left and right direction in the center part of the substrate unit rear face 83S1.

The integrated circuit 836 is electrically connected to devices built into the first lens barrel 811 (such as various actuators) by plugging the distal end of the first lens barrel flexible substrate 200 into the first lens barrel connector 831. Similarly, the integrated circuit 836 is electrically connected to devices built into the second lens barrel 812 (such as various actuators) by plugging the distal end of the second lens barrel flexible substrate 220 into the second lens barrel connector 834. Also, the integrated circuit 836 is electrically connected to the first imaging element 811b of the first lens barrel 811 by plugging the distal end of the first imaging element flexible substrate 210 into the first imaging element connector 832. Similarly, the integrated circuit 836 is electrically connected to the second imaging element 812b of the second lens barrel 812 by plugging the distal end of the second imaging element flexible substrate 230 into the second lens barrel connector 834.

As shown in FIG. 11, the integrated circuit 836 here is surrounded by the first lens barrel connector 831, the second lens barrel connector 834, the first imaging element connector 832, and the second imaging element connector 835. Specifically, the four connectors are disposed in a balanced fashion around the outer periphery of the integrated circuit 836 without overlapping the integrated circuit 836 in the forward and backward direction. Also, the spacing between the four connectors and the integrated circuit 836 is designed to be substantially the same for each.

Also, the integrated circuit 836 is sandwiched between the lens barrel unit 81 and the substrate unit 83. The integrated circuit 836 is close to the lens barrel linking plate 810 of the lens barrel unit 81, with a specific spacing in between.

Action and Effect

(1) The digital camera 100 pertaining to this embodiment comprises the lens barrel linking plate 810, the frame unit 82, and the first and second lens barrels 811 and 812. The frame unit 82 has the first to third bosses 821 to 823 linked to the lens barrel linking plate 810. The first and second lens barrels 811 and 812 are disposed between the frame unit 82 and the lens barrel linking plate 810. The first to third bosses 821 to 823 are disposed around the outer periphery of the first lens barrel 811.

Since the first to third bosses 821 to 823 are thus disposed around the outer periphery of the first lens barrel 811, there will be less distortion of the lens barrel linking plate 810 as a whole when the lens barrel linking plate 810 is linked to the frame unit 82, than when the first to third bosses 821 to 823 are disposed around the outer periphery of the first and second lens barrels 811 and 812, that is, when the first to third bosses 821 to 823 are disposed around the outer edge of the lens barrel linking plate 810. Therefore, there is less deviation in the optical axes of the first and second lens barrels 811 and 812.

(2) The frame unit 82 extends in a specific direction. The first lens barrel 811 is disposed at a position that is closer to the center of the frame unit 82 than the second lens barrel 812 in a specific direction.

Since the first to third bosses 821 to 823 are thus disposed on the inside of the frame unit 82, there is less of the direct transmission of impact force exerted on the digital camera 100 to the lens barrel linking plate 810 than when the first to third bosses 821 to 823 are disposed on the outer edge of the frame unit 82.

(3) The first and second bosses 821 and 822 are disposed between the first and second lens barrels 811 and 812, and the third boss 823 is disposed on the opposite side from the first and second bosses 821 and 822 with the first lens barrel 811 sandwiched in between.

Since the middle of the lens barrel linking plate 810 can thus be supported by the two bosses, the lens barrel linking plate 810 can be supported with better balance than when the end of the lens barrel linking plate 810 is supported by the two bosses.

(4) The lens barrel linking plate 810 has the first and second tabs 810d and 810e that protrude outward from the end on the second lens barrel 812 side.

Therefore, there is less of the direct transmission of impact force exerted on the digital camera 100 to the lens barrel linking plate 810.

(5) As shown in FIG. 11, the first lens barrel connector 831, the second lens barrel connector 834, the first imaging element connector 832, and the second imaging element connector 835 are disposed so as to surround the integrated circuit 836.

Therefore, it is easier to wire from each of the first lens barrel connector 831 and the second lens barrel connector 834 to the integrated circuit 836. In addition, a wiring length between the first imaging element connector 832 and the integrated circuit 836 is the same a wiring length between the second imaging element connector 835 and the integrated circuit 836. Therefore, it is easier to ensure good signal quality from the imaging elements to the integrated circuit 836.

(6) The integrated circuit 836 is sandwiched between the substrate unit 83 and the lens barrel unit 81, and is close to the lens barrel linking plate 810.

Therefore, any heat generated by the integrated circuit 836 (including radiant heat) can be efficiently transmitted to the lens barrel linking plate 810, which promotes heat dissipation from the integrated circuit 836.

### Other Embodiments

The present invention was described above through an embodiment, but the description and drawings that form part of this disclosure should not be construed as limiting this invention. Various alternative embodiments, working examples, and applied technology should be clear to a person skilled in the art from this disclosure.

(A) In the above embodiment, a case was described in which the digital camera 100 had two lens barrels, but this is not the only option. The digital camera 100 may have three or more lens barrels.

(B) In the above embodiment, the first to third bosses 821 to 823 were disposed between the first and second lens barrels 811 and 812, and the third boss 823 was disposed on the opposite side from the first and second bosses 821 and 822 with the first lens barrel 811 sandwiched in between, but this is not the only option. One boss may be disposed between the first and second lens barrels 811 and 812, and two bosses may be disposed on the opposite side from the second lens barrel 812.

(C) In the above embodiment, the digital camera 100 was described as an example of an “imaging device,” but this is not the only option. Examples of imaging devices include video cameras, portable telephones, IC recorders, and so on.

Thus, the present invention of course includes various embodiments and so forth that have not been discussed herein. Therefore, the technological scope of the present invention is determined solely by the invention-defining matter pertaining to the appropriate patent claims from the description given above.

General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the imaging device. Accordingly, these terms, as utilized to describe the technology disclosed herein should be interpreted relative to imaging device.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicants, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An imaging device, comprising:
a frame unit;
a linking frame having a first linking component, a second linking component, and a third linking compenent, the first, second, and third linking components being linked to the frame unit; and
a first lens barrel and a second lens barrel, the first and second lens barrels disposed between the frame unit and the linking frame; wherein
the first, second, and third linking components are disposed around an outer periphery of the first lens barrel.

2. The imaging device according to claim 1, wherein
the linking frame extends in a specific direction, and
the first lens barrel is closer to a center of the linking frame than the second lens barrel.

3. The imaging device according to claim 1, wherein
the first and second linking components are disposed between the first and second lens barrels, and
the third linking component is disposed on the opposite side of the first lens barrel from the first and second linking components.

4. The imaging device according to claim 3, wherein
the frame unit has a latching component that protrudes outward from an edge of the frame unit nearest to the second lens barrel, and
the latching component is latched to the linking frame.

5. The imaging device according to claims 1, wherein
the frame unit includes:
an insertion hole into which a screw is inserted, and
two convex components that protrude toward the first lens barrel;
the first lens barrel is configured to hit the two convex components; and
the frame unit is linked to the panel member by the screw.
